(19) United States
(12) Patent Application Publication
(10) Pub. No.: US 2026/0290043 A1
(43) Pub. Date: Sep. 24, 2026

(54) INFORMATION PROCESSING DEVICE, INFORMATION PROCESSING SYSTEM, INFORMATION PROCESSING METHOD, AND STORAGE MEDIUM

(71) Applicant: HONDA MOTOR CO., LTD., Tokyo (JP)

(72) Inventors: Shinichi Murakami, Wako-shi (JP); Tetsuya Gomi, Tokyo (JP); Yoko Umeyama, Tokyo (JP); Taiki Iwama, Tokyo (JP); Masahiro Kimura, Wako-shi (JP); Ryuji Iwashita, Wako-shi (JP); Seungho Choi, Wako-shi (JP); Kotaro Masuda, Wako-shi (JP); Yuji Yasui, Wako-shi (JP); Jing Zhao, Tokyo (JP); Adil Gupta, Tokyo (JP); Ryo Takebayashi, Tokyo (JP)

(21) Appl. No.: 19/550,395

(22) Filed: Feb. 26, 2026

(30) Foreign Application Priority Data
Mar. 24, 2025 (JP) 2025-048696

(51) Int. Cl. G06V 20/59; B60Q 9/00; G06V 40/16

(52) U.S. Cl. CPC G06V 20/597; B60Q 9/00; G06V 40/16

(57) ABSTRACT

An information processing device includes a risk detection unit configured to detect a risk object positioned surrounding a vehicle, an acquisition unit configured to acquire a face image of a driver of the vehicle, an overlooking determination unit configured to determine presence or absence of overlooking of the risk object by the driver on the basis of information relating to a position of the risk object and information relating to the face image, an abnormality determination unit configured to determine whether an abnormality occurs in the driver on the basis of a trend of transition of the presence or absence of the overlooking, and a notification control unit configured to cause a notification unit to perform a notification when determination is made that the abnormality occurs in the driver.

### CROSS-REFERENCE TO RELATED APPLICATION

Priority is claimed on Japanese Patent Application No. 2025-048696, filed Mar. 24, 2025, the content of which is incorporated herein by reference.

### BACKGROUND OF THE INVENTION

### Field of the Invention

The present invention relates to an information processing device, an information processing system, an information processing method, and a storage medium.

### Description of Related Art

In recent years, efforts have been actively made to provide access to a sustainable transportation system with special attention to people in vulnerable situations such as aged people, people with disabilities, and children among traffic participants. To implement this, research and development for further improving the safety or convenience of traffic through development on means for transportation for aged people or people with disabilities has been focused on (for example, see Patent Documents 1 and 2 described below).

[Patent Document 1] Japanese Unexamined Patent Application, First Publication No. 2020-71528

[Patent Document 2] Japanese Unexamined Patent Application, First Publication No. 2017-16568

### SUMMARY OF THE INVENTION

When an abnormality occurs in the driver such as when the driver is suffering from a disease such as visual field loss or dementia or when the driver has accumulated fatigue, a driver's ability to avoid a risk object is reduced. However, the driver may be unaware of such a disease or accumulation of fatigue. When the driver continues driving while being unaware of the disease, fatigue, and reduction in ability due to the disease or fatigue, there is a possibility that the safety or convenience of traffic is impaired.

An aspect according to the present invention has been made in consideration of such a situation, and an object of the present invention is to provide an information processing device, an information processing system, an information processing method, and a storage medium capable of detecting an abnormality of a driver. The present invention, in turn, contributes to development of a sustainable transportation system.

To solve the above-described problem, the present invention employs the following aspects.
(1) An information processing device according to an aspect of the present invention includes a risk detection unit configured to detect a risk object positioned surrounding a vehicle, an acquisition unit configured to acquire a face image of a driver of the vehicle, an overlooking determination unit configured to determine presence or absence of overlooking of the risk object by the driver on the basis of information relating to a position of the risk object and information relating to the face image, an abnormality determination unit configured to determine whether an abnormality occurs in the driver on the basis of a trend of transition of the presence or absence of the overlooking, and a notification control unit configured to cause a notification unit to perform a notification when determination is made that the abnormality occurs in the driver.
(2) In the aspect of (1) described above, the abnormality determination unit may be configured to calculate a frequency value of the overlooking for each of a plurality of first calculation periods included in a first determination period, and determine that a first abnormality occurs in the driver when the frequency value is equal to or greater than a first threshold determined on the basis of a past frequency value of overlooking only in some first calculation periods among the plurality of first calculation periods, and the notification control unit may be configured to cause the notification unit to perform a first notification when determination is made that the first abnormality occurs in the driver.
(3) In the aspect of (1) or (2) described above, the abnormality determination unit may be configured to calculate a frequency value of the overlooking for each of a plurality of second calculation periods included in a second determination period, and determines that a second abnormality occurs in the driver when the frequency value is equal to or greater than a second threshold determined on the basis of a past frequency value of overlooking in all second calculation periods among the plurality of second calculation periods, and the notification control unit may be configured to cause the notification unit to perform a second notification when the second abnormality occurs in the driver.
(4) In the aspect of any one of (1) to (3) described above, the abnormality determination unit may be configured to calculate a frequency value of the overlooking for each of a plurality of third calculation periods included in a third determination period, and determine that a third abnormality occurs in the driver when a variation value of the frequency value in the plurality of third calculation periods is equal to or greater than a third threshold, and the notification control unit may be configured to cause the notification unit to perform a third notification when determination is made that the third abnormality occurs in the driver.
(5) In the aspect of any one of (1) to (4) described above, the abnormality determination unit may be configured to specify a sleepiness period during which the driver has sleepiness, on the basis of the face image, and determine whether the abnormality occurs in the driver on the basis of the presence or absence of the overlooking in a period other than the specified sleepiness period.
(6) In the aspect of (5) described above, the abnormality determination unit may be configured to specify the sleepiness period on the basis of the number of times of opening/closing an eyelid of the driver and/or an opening degree of the eyelid detected from the face image.
(7) An information processing system according to an aspect of the present invention includes the information processing device of the aspect of any one of (1) to (6) described above, a first terminal device that is used by the driver and is not the notification unit in which the notification is controlled by the notification control unit, and a second terminal device that is used by a user different from the driver and is the notification unit in which the notification is controlled by the notification control unit, in which the second terminal device causes the first terminal device to perform a notification on the basis of information input by an operation of the user.
(8) An information processing method according to an aspect of the present invention causes a computer to execute processing of detecting a risk object positioned surrounding a vehicle, processing of acquiring a face image of a driver of the vehicle, processing of determining presence or absence of overlooking of the risk object by the driver on the basis of information relating to a position of the risk object and information relating to the face image, processing of determining whether an abnormality occurs in the driver on the basis of a trend of transition of the presence or absence of the overlooking, and processing of causing a notification unit to perform a notification when determination is made that the abnormality occurs in the driver.
(9) A non-transitory computer-readable storage medium according to an aspect of the present invention stores a program causing a computer to execute processing of detecting a risk object positioned surrounding a vehicle, processing of acquiring a face image of a driver of the vehicle, processing of determining presence or absence of overlooking of the risk object by the driver on the basis of information relating to a position of the risk object and information relating to the face image, processing of determining whether an abnormality occurs in the driver on the basis of a trend of transition of the presence or absence of the overlooking, and processing of causing a notification unit to perform a notification when determination is made that the abnormality occurs in the driver.

According to the aspects of the present invention, it is possible to detect an abnormality of the driver.

### BRIEF DESCRIPTION OF THE DRAWINGS

FIG. 1 is a diagram showing an example of a configuration and a usage environment of a driving monitoring device including an information processing device according to a first embodiment.

FIG. 2 is a diagram showing an example of the driving monitoring device.

FIG. 3 is a diagram showing an example of an image acquired by the driving monitoring device.

FIG. 4 is a diagram illustrating overlooking alarm processing that is performed by the driving monitoring device.

FIG. 5 is a diagram showing an example of information that is detected by a detection unit.

FIG. 6 is a diagram showing an example of an alarm that is performed by an alarm unit.

FIG. 7 is a diagram illustrating abnormality notification processing that is performed by the driving monitoring device.

FIG. 8 is a diagram showing an example of determination history information.

FIG. 9 is a flowchart illustrating an example of a flow of processing that is executed by an abnormality determination unit.

FIG. 10 is a diagram illustrating abnormality notification processing in an information processing system according to a second embodiment.

### DETAILED DESCRIPTION OF THE INVENTION

Hereinafter, an embodiment of an information processing device, an information processing system, an information processing method, and a storage medium of the present invention will be described with reference to the drawings. In the following description, a front direction of a vehicle is referred to as a plus X direction, a rear direction of the vehicle is referred to as a minus X direction, a right direction that is a width direction of the vehicle with respect to the plus X direction is referred to as a plus Y direction, a left direction is referred to as a minus Y direction, and a height direction of the vehicle that is a direction perpendicular to the X direction and the Y direction is referred to as a plus Z direction.

### First Embodiment

### Overall Configuration

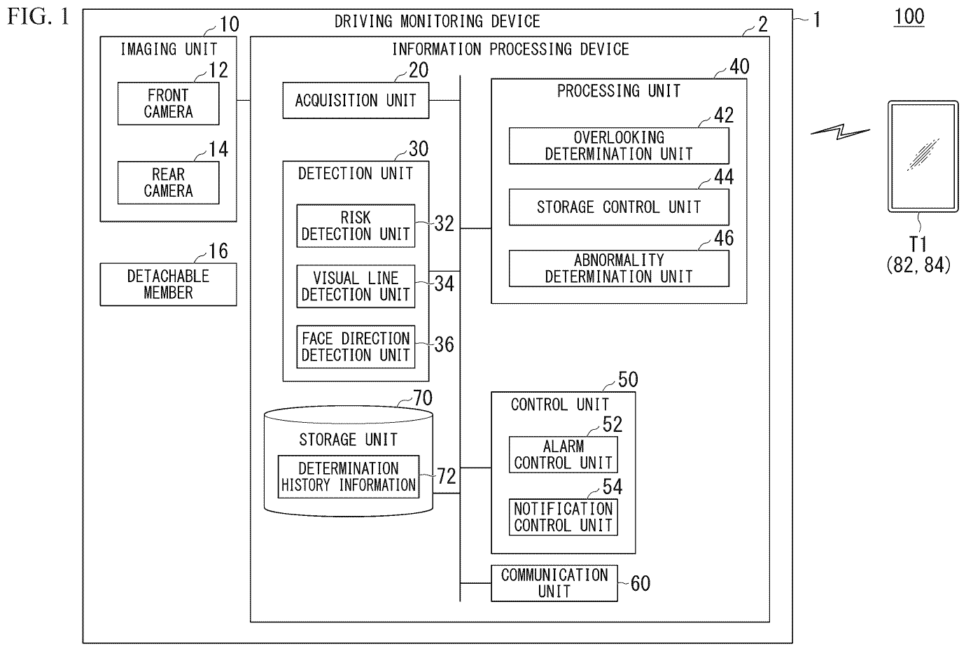

FIG. 1 is a diagram showing an example of a configuration and a usage environment of a driving monitoring device 1 including an information processing device 2 according to a first embodiment. The information processing device 2 is mounted in, for example, the driving monitoring device 1 that is retrofitted to a vehicle (hereinafter, referred to as a “vehicle M”) such as a drive recorder. That is, the driving monitoring device 1 (information processing device 2) is attachable and detachable to and from the vehicle M via a detachable member (hereinafter, referred to as a “detachable member 16”). The information processing device 2 is, for example, a device that is not connected to an in-vehicle network of the vehicle M. The in-vehicle network is an in-vehicle network using a communication standard such as a controller area network (CAN) to which an electronic control unit (ECU) regarding starting, braking, steering of the vehicle M, or vehicle control such as various sensors of the vehicle, operation members regarding driving, and operation buttons is connected. A network of the vehicle M for a human machine interface (HMI) may be excluded from the in-vehicle network.

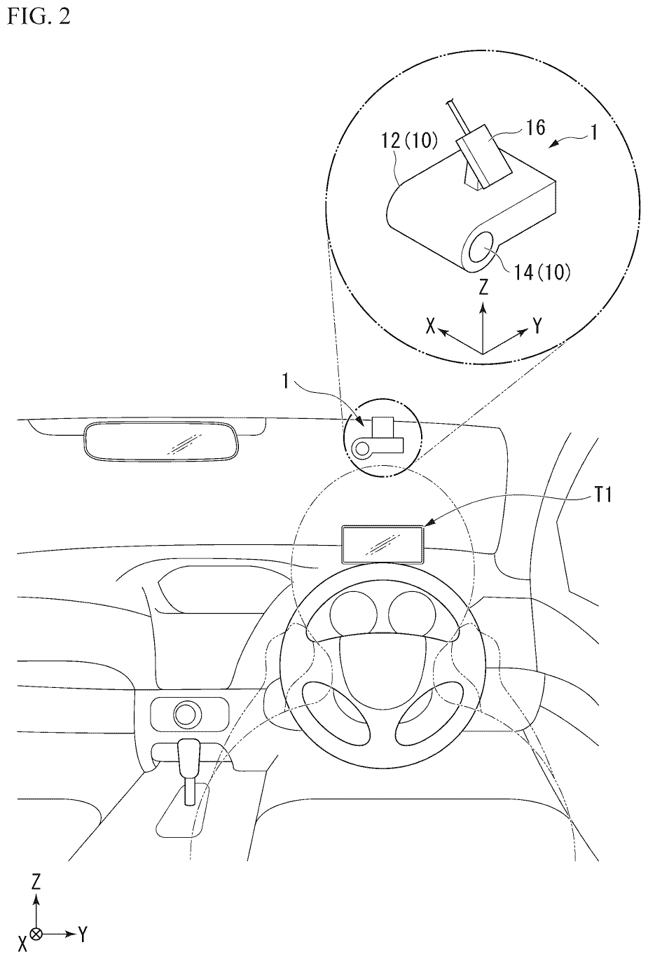

FIG. 2 is a diagram showing an example of the driving monitoring device 1. The driving monitoring device 1 is attached to, for example, a position in the vicinity of a front windshield of the vehicle M and near the front of a driver's seat. The driving monitoring device 1 stores an image (video) captured by the imaging unit 10 in, for example, a storage unit 70 (described below). The driving monitoring device 1 includes, for example, a display device such as a liquid crystal display (LCD), and may be configured to display an image (video) stored in the storage unit 70 on the display device.

The driving monitoring device 1 includes, for example, an imaging unit 10, the detachable member 16, and the information processing device 2. In the example shown in the drawing, the imaging unit 10 includes a front camera 12 and a rear camera 14.

Each of the front camera 12 and the rear camera 14 is, for example, a digital camera using a solid-state imaging element such as a charge coupled device (CCD) or a complementary metal oxide semiconductor (CMOS). The front camera 12 repeatedly (periodically) images the surroundings in front of the vehicle M from a position where the driving monitoring device 1 is attached. The rear camera 14 repeatedly (periodically) images the surroundings behind the vehicle M and the inside of a vehicle cabin of the vehicle M from the position where the driving monitoring device 1 is attached. An angle of view in a horizontal direction at which each of the front camera 12 and the rear camera 14 images is, for example, 180° or more. That is, the driving monitoring device 1 (imaging unit 10) images a range of 360° surrounding the vehicle M from the attached position. Each of the front camera 12 and the rear camera 14 may be, for example, a fisheye camera including a fisheye lens. Alternatively, each of the front camera 12 and the rear camera 14 may be a wide angle camera or the like. In the present embodiment, while a case where the front camera 12 and the rear camera 14 are used will be described, other cameras may be used instead of or in addition to the front camera 12 and the rear camera 14. That is, the imaging unit 10 may be configured such that an image (a surrounding image and a face image described below) for use in the present embodiment is imaged.

The detachable member 16 is, for example, a member for mounting the driving monitoring device 1 on the vehicle M. The detachable member 16 is any member, for example, a support member such as a sucker, a seal, or a bracket. The detachable member 16 may include a power supply cable (wire or the like) for supplying power to the driving monitoring device 1.

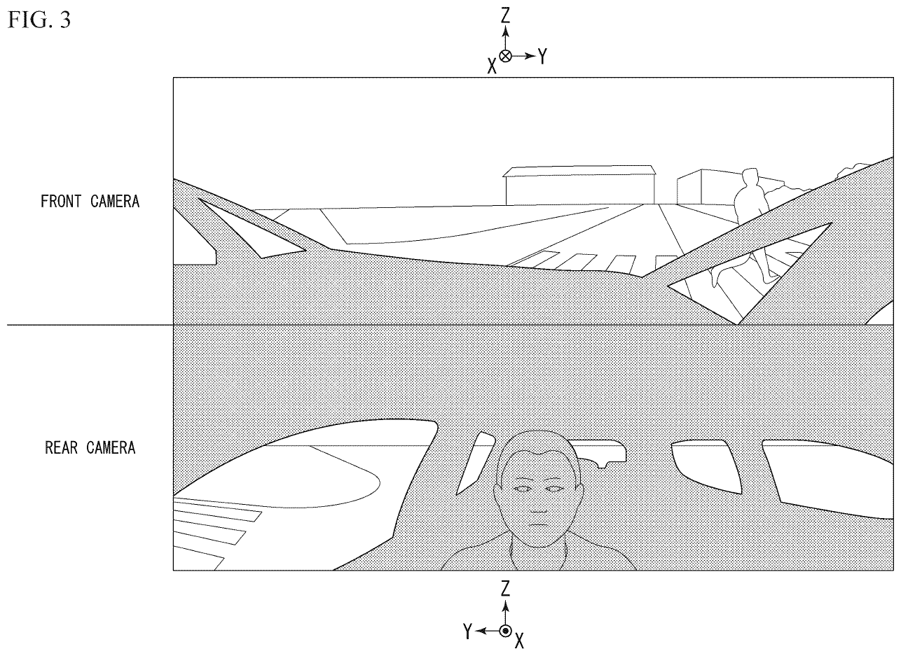

FIG. 3 is a diagram showing an example of an image acquired by the driving monitoring device 1. That is, FIG. 3 is a diagram showing an example of an image captured by the imaging unit 10. The front camera 12 images the front view of the vehicle M over a front windshield, a window on a driver's seat side, and a window on an assistant driver's seat side. The rear camera 14 images the inside (an occupant including a driver) of the vehicle cabin of the vehicle M, the rear view of the vehicle M over the window on the driver's seat side, the window on the assistant driver's seat, and a rear windshield, and the like.

In an image (hereinafter, referred to as a “front image”) captured by the front camera 12, as a subject, for example, the front view of the vehicle M seen through the front windshield such as another vehicle, a pedestrian, a bicycle, a fixed object, a road marking line and an object present on the right and left (front) of the vehicle M seen through the right and left windows are reflected.

In an image (hereinafter, referred to as a “rear image”) captured by the rear camera 14, the inside of the vehicle cabin of the vehicle M, the rear view of the vehicle M seen through the rear windshield, and an object present on the right and left (rear) of the vehicle M seen through the right and left windows are reflected. For this reason, in a rear view captured by the rear camera 14, as a subject, at least the driver of the vehicle M to which the driving monitoring device 1 is attached is reflected.

In the front image and the rear image, an image (hereinafter, referred to as a “surrounding image”) in which a surrounding situation of the vehicle M is imaged is included. In the rear image, an image (hereinafter, referred to as a “face image”) in which the face of the driver of the vehicle M is image is included. The driving monitoring device 1 may be attached on any place as long as the surrounding image and the face image can be captured by the imaging unit 10.

The information processing device 2 (see FIG. 1) outputs an alarm and notification via a first terminal device T1 on the basis of a result obtained by referring to the surrounding image and the face image output from the imaging unit 10. The driving monitoring device 1 and the first terminal device T1 may be collectively referred to as an “information processing system 100”.

The first terminal device T1 is, for example, a portable terminal device such as a smartphone or a tablet terminal that is used by the driver who drives the vehicle M to which the driving monitoring device 1 is attached. In the first terminal device T1, for example, an application for receiving an alarm and notification from the information processing device 2 is executed. The application displays an image based on information (for example, alarm information and notification information described below) transmitted from the information processing device 2 on the display device or causes a speaker to emit sound. The first terminal device T1 is also referred to as an alarm unit 82 and a notification unit 84. The first terminal device T1 is used in a state of being detachably attached to the vehicle M, for example. For example, a holder for the first terminal device T1 having a detachable member is provided in one or both of the first terminal device T1 and the vehicle M, and the first terminal device T1 is supported by the holder.

A navigation, a display unit, or a speaker of the vehicle M may be used instead of the first terminal device T1. That is, the navigation, the display unit, or the speaker of the vehicle M may output an alarm or notification on the basis of an instruction of the information processing device 2. That is, the navigation of the vehicle M or the display unit or the speaker of the vehicle M may be the alarm unit 82 or the notification unit 84. A display unit (the alarm unit 82 and the notification unit 84), a speaker (the alarm unit 82 and the notification unit 84), or the like may be provided in the driving monitoring device 1 instead of the first terminal device T1.

As shown in FIG. 1, the information processing device 2 includes, for example, an acquisition unit 20, a detection unit 30, a processing unit 40, a control unit 50, a communication unit 60, and a storage unit 70. The detection unit 30 includes a risk detection unit 32, a visual line detection unit 34, and a face direction detection unit 36. The processing unit 40 includes an overlooking determination unit 42, a storage control unit 44, and an abnormality determination unit 46. The control unit 50 includes an alarm control unit 52 and a notification control unit 54.

For the acquisition unit 20, the detection unit 30, the processing unit 40, and the control unit 50, the function of each component is implemented, for example, by providing a hardware processor such as a central processing unit (CPU) and a storage device (a storage device including a non-transitory storage medium) storing a program (software) and causing the processor to execute the program. Some or all of these components may be implemented by hardware (including a circuit unit; circuitry) such as a large scale integration (LSI), an application specific integrated circuit (ASIC), a field-programmable gate array (FPGA), or a graphics processing unit (GPU) or the function of each component may be implemented by cooperation of software and hardware. For some or all of these components, the function of each component may be implemented by a dedicated LSI.

The program (software) may be stored in advance in the storage unit 70 (a storage device including a non-transitory storage medium) such as a read only memory (ROM), a random access memory (RAM), or a flash memory in the information processing device 2 or may be stored in a removable storage medium (a non-transitory storage medium) such as a memory card and installed on the storage device when the storage medium is loaded into the driving monitoring device 1. The program (software) may be downloaded from another computer device through short-range communication or wide area communication by the application executed on the first terminal device T1, transmitted from the first terminal device T1, and installed on the storage device.

In the storage unit 70, for example, determination history information 72, a program (for example, the program described above), and various other kinds of information are stored. The storage unit 70 may be implemented by various storage devices described above, an electrically erasable programmable read only memory (EEPROM), or the like. The communication unit 60 is an interface for performing wireless communication or wired communication with an information processing device (external device) such as the first terminal device T1.

The driving monitoring device 1 (information processing device 2) performs at least overlooking alarm processing and abnormality notification processing. The overlooking alarm processing is processing of detecting overlooking of a risk object by the driver on the basis of the surrounding image and the face image and causing the alarm unit 82 to give an alarm. The abnormality notification processing is processing of detecting an abnormality (fatigue, visual field narrowing, dementia) on the basis of a trend of transition of the presence or absence of the overlooking (that is, what trend of transition the presence or absence of the overlooking has) and causing the notification unit 84 to perform a notification.

The risk object is, for example, an object that the vehicle M should avoid. The risk object is, for example, an object with which the vehicle M interferes or is likely to interfere when moving in the present state. The object with which the vehicle M is likely to interfere is, for example, an object of which a degree of approach is equal to or greater than a predetermined degree after a predetermined time when a position, a moving direction, and a moving speed of an object and a position, a moving method, and a moving speed of the vehicle M are taken into consideration. The object may be a traffic participant such as a pedestrian, a bicycle, or a vehicle or may be an object such as an object placed on a road or a fallen object other than the traffic participant.

### Overlooking Alarm Processing

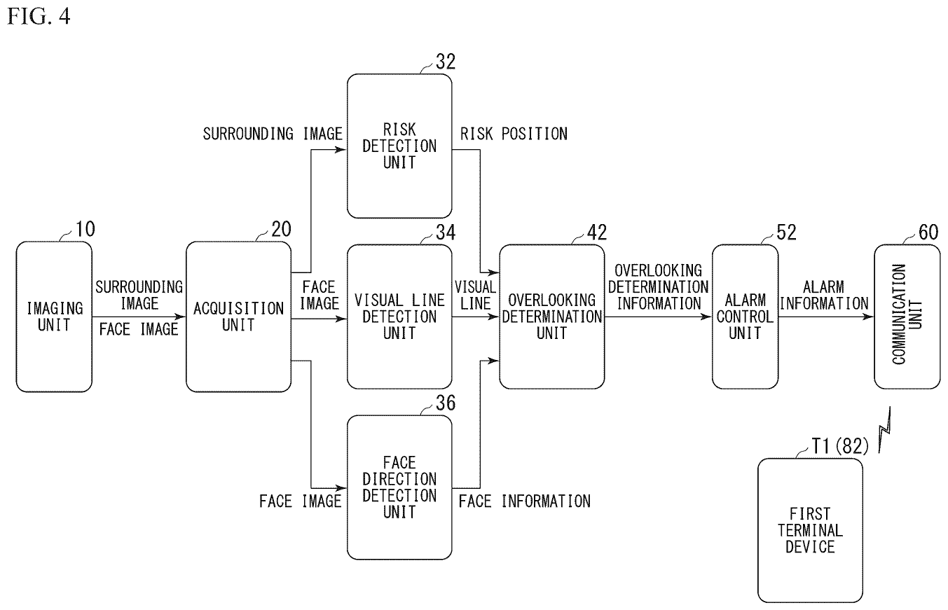

FIG. 4 is a diagram illustrating the overlooking alarm processing that is performed by the driving monitoring device 1 (information processing device 2).

The acquisition unit 20 acquires a front image and a rear image from the imaging unit 10. With this, the acquisition unit 20 acquires a surrounding image and a face image in association with each other. Because the imaging unit 10 repeatedly (periodically) captures the surrounding image and the face image, the acquisition unit 20 repeatedly (periodically) acquires the surrounding image and the face image. The acquisition unit 20 may acquire the surrounding image and the face image in association with a time (imaging time) at which these images are captured.

The risk detection unit 32 detects a risk object in the surrounding image. “Detecting a risk object” means, for example, detecting the presence of the risk object and a position (hereinafter, referred to as a risk position) of the risk object with respect to the vehicle M (driving monitoring device 1). For example, reference information (not shown) indicating a relationship between a risk position in the surrounding image and a relative position with respect to the vehicle M may be stored in advance in the storage unit 70. The risk detection unit 32 may detect the position of the risk object with respect to the vehicle M on the basis of the reference information.

The risk detection unit 32 detects a presence direction (approach direction) of a risk object with respect to the vehicle M by detecting the relative position of the risk object with respect to the vehicle M. “A presence direction of a risk object” means, for example, the presence direction of the risk object approaching the vehicle M (driving monitoring device 1) with respect to the vehicle M (driving monitoring device 1). Hereinafter, “the presence direction of the risk object” may be referred to as a “risk presence direction”.

The visual line detection unit 34 detects a visual line of the driver in the face image. Specifically, the visual line detection unit 34 detects the visual line of the driver by analyzing the face image using a predetermined image analysis method. “Detecting a visual line” means, for example, detecting a position of an eyeball of the driver and a direction of the visual line (a direction of the eyeball).

The face direction detection unit 36 detects at least a direction of a face of the driver in the face image. Specifically, the face direction detection unit 36 detects the direction of the face of the driver by analyzing the face image using a predetermined image analysis method. The face direction detection unit 36 may detect a position of the face of the driver in addition to the direction of the face of the driver. Hereinafter, information in which “the direction of the face” and “the position of the face” are combined may be referred to as “face information”. The face direction detection unit 36 detects the face information in the face image.

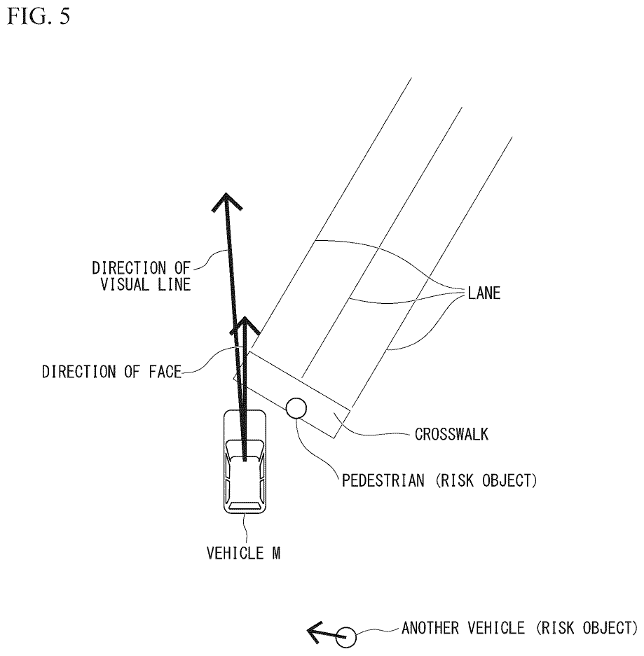

The detection unit 30 may be configured to detect a lane, a crosswalk, or the like in addition to the risk object, the visual line, and the face information described above. FIG. 5 is a diagram showing an example of information that is detected by the detection unit 30. In the example of FIG. 5, a pedestrian, another vehicle, lanes, and a crosstalk detected by the detection unit 30 are shown with the vehicle M, the direction of the visual line, and the direction of the face as a reference. The pedestrian and another vehicle are an example of a traffic participant (object) that is likely to be a risk object. For information that is detected by the detection unit 30, a traffic participant (object) that is detected by the detection unit 30 and is likely to be a risk object may be shown with the vehicle M, a direction of the vehicle M, and/or a proceeding direction of the vehicle M as a reference instead of the vehicle M, the direction of the visual line, and the direction of the face.

The overlooking determination unit 42 (see FIG. 4) determines the presence or absence of overlooking of a risk object by the driver on the basis of the risk position and/or the risk presence direction, the visual line, and the face information. Each of the “risk position” and the “risk presence direction” is an example of “information relating to a position of a risk object”. The visual line and the face information are an example of “information relating to a face image”.

For example, reference information (not shown) indicating a relationship between the direction of the eyeball (visual line) and/or the direction of the face of the driver in the face image and a relative direction with respect to the proceeding direction of the vehicle M may be stored in advance in the storage unit 70. The overlooking determination unit 42 may determine whether the direction of the visual line and/or the direction of the face match the risk presence direction with reference to the reference information. When the direction of the visual line and/or the direction of the face match the risk presence direction, the overlooking determination unit 42 may determine that the driver visually recognizes the risk object. “A case where the direction of the visual line and/or the direction of the face match the risk presence direction” may be, for example, a case where the risk position is present on a straight line along the direction of the visual line and/or the direction of the face. Alternatively, “a case where the direction of the visual line and/or the direction of the face match the risk presence direction” may be a case where the risk position is present in a conical area which has a center axis along the direction of the visual line and/or the direction of the face with the position of the visual point (eyeball) and/or the face as a vertex and in which the side spreads toward the front. When the direction of the visual line and/or the direction of the face do not match the position of the risk object, the overlooking determination unit 42 may determine that the driver does not visually recognize the risk object.

The overlooking determination unit 42 may determine that the overlooking of the risk object by the driver is present when a state in which the driver does not visually recognize the risk object is continued for a predetermined time or more. The overlooking determination unit 42 may determine that the overlooking of the risk object by the driver is absent when the driver visually recognizes the risk object or when a state in which the driver does not visually recognize the risk object is resolved before the predetermined time elapses. It should be noted that a determination method of overlooking by the overlooking determination unit 42 is not limited to the above-described method, and can be suitably changed.

The overlooking determination unit 42 generates overlooking determination information on the basis of the determination result. In the overlooking determination information, for example, the presence or absence of overlooking and the risk presence direction described above are included.

The alarm control unit 52 causes the first terminal device T1 (alarm unit 82) to output an alarm on the basis of the overlooking determination information. For example, the alarm control unit 52 transmits alarm information to the first terminal device T1 via the communication unit 60. In the alarm information, for example, information indicating the necessity for an alarm and the risk presence direction are included. The alarm control unit 52 generates alarm information including information indicating that “an alarm is necessary”, for example, when information indicating that “overlooking is present” is included in the overlooking determination information. The alarm control unit 52 generates alarm information including information indicating that “an alarm is not necessary”, for example, when information indicating that “an overlooking is absent” is included in the overlooking determination information. The first terminal device T1 outputs an alarm on the basis of the alarm information.

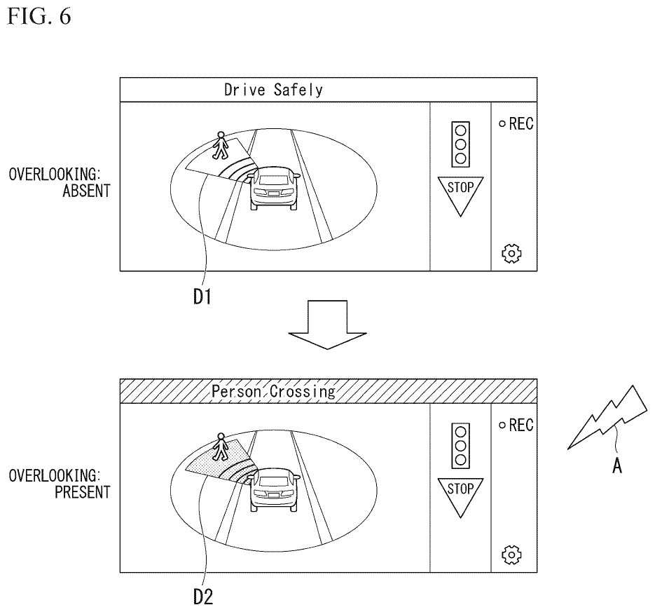

FIG. 6 is a diagram showing an example of an alarm that is performed by the first terminal device T1 (alarm unit 82). In the example of FIG. 6, the first terminal device T1 displays contents in which the risk presence direction (in the drawing, D1 and D2) can be recognized. Then, the first terminal device T1 performs an alarm by making a display aspect of the risk presence direction different between when the overlooking of the risk object is present (that is, when information indicating that “an alarm is necessary” is included in the alarm information) and when the overlooking of the risk object is absent (that is, when information indicating that “an alarm is not necessary” is included in the alarm information). Specifically, when the overlooking of the risk object is present, the risk presence direction is displayed in a more emphasized aspect compared to when the overlooking is absent. The emphasized aspect may be, for example, an aspect that allows the driver to more easily visually recognize the risk presence direction such as emphasis by color or emphasis by blinking or turning on an icon or the like. The first terminal device T1 may perform an alarm through emission of sound by a speaker or light emission of a light in addition to or instead of the above-described method (in the drawing, A). A specific method of an alarm can be suitably changed as long as the alarm can be recognized by the driver.

The alarm by the first terminal device T1 (alarm unit 82) may be performed, for example, at a timing at which the driver is driving the vehicle M (that is, in real time). Examples of “the timing at which the driver is driving the vehicle M” include a timing at which the vehicle M is traveling and a timing at which the vehicle M is temporarily stopped. For example, the transmission of the alarm information by the alarm control unit 52 may be performed at the above-described timing. Alternatively, the transmission of the alarm information by the alarm control unit 52 may be performed at any timing, and the first terminal device T1 (alarm unit 82) may control the timing of the alarm such that the alarm is performed at the above-described timing.

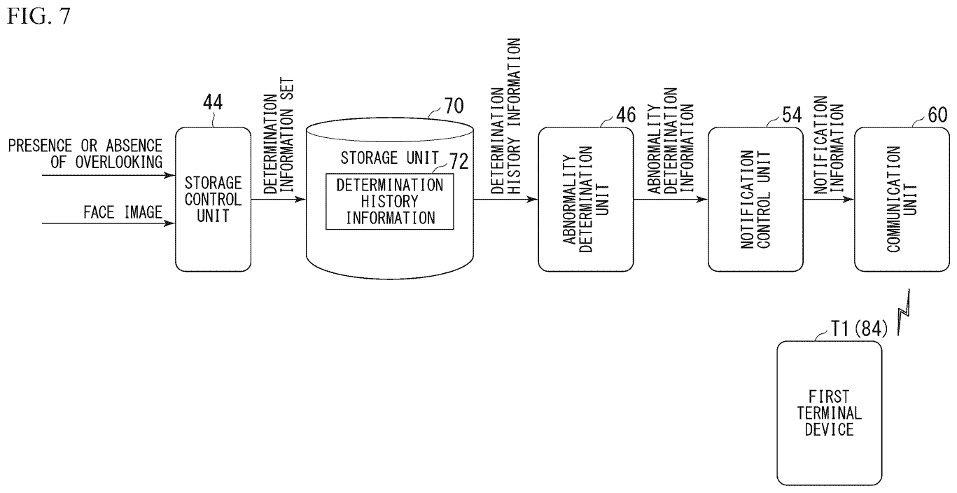

FIG. 7 is a diagram illustrating the abnormality notification processing that is performed by the driving monitoring device 1 (information processing device 2).

The storage control unit 44 stores a determination time, the presence or absence of the overlooking of the risk object, and the face image in the storage unit 70 in association with one another. The determination time corresponds to, for example, the imaging time of the surrounding image and/or the face image used for the determination of the presence or absence of the overlooking. The above-described processing (storage processing) by the storage control unit 44 is performed, for example, each time the overlooking determination information is generated by the overlooking determination unit 42. Hereinafter, information stored in the storage unit 70 in such a manner is referred to as the determination history information 72.

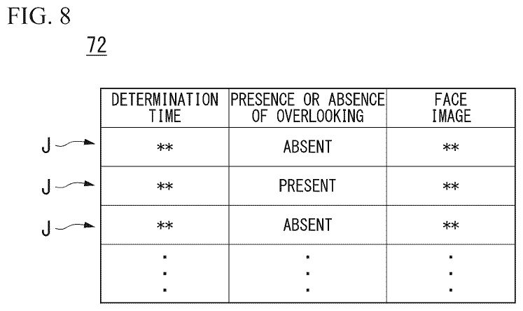

FIG. 8 is a diagram showing an example of the determination history information 72. The above-described storage processing is repeated by the storage control unit 44, so that a plurality of sets (hereinafter, referred to as a determination information set J) of information including the determination time, the presence or absence of the overlooking, and the face image are accumulated in the determination history information 72. That is, the storage control unit 44 generates the determination information set J each time the overlooking determination information is generated by the overlooking determination unit 42. Then, the storage control unit 44 updates the determination history information 72 by adding the generated determination information set J to the determination history information 72.

Returning to FIG. 7, the abnormality determination unit 46 determines whether an abnormality occurs in the driver, on the basis of the determination history information 72. Specifically, the abnormality determination unit 46 determines the presence or absence of occurrence of a first abnormality, the presence or absence of occurrence of a second abnormality, and the presence or absence of occurrence of a third abnormality, in the driver on the basis of a trend of transition of the presence or absence of the overlooking included in the determination history information 72.

The first abnormality is, for example, that fatigue is accumulated or is likely to be accumulated. The second abnormality is, for example, the drier is suffering from or is likely to be suffering from visual field loss such as visual field narrowing. The third abnormality is, for example, that the driver is suffering from or is likely to be suffering from dementia. The abnormality determination unit 46 generates abnormality determination information on the basis of a determination result. In the abnormality determination information, for example, information indicating the presence or absence of the first abnormality, information indicating the presence or absence of the second abnormality, and information indicating the presence or absence of the third abnormality described above are included.

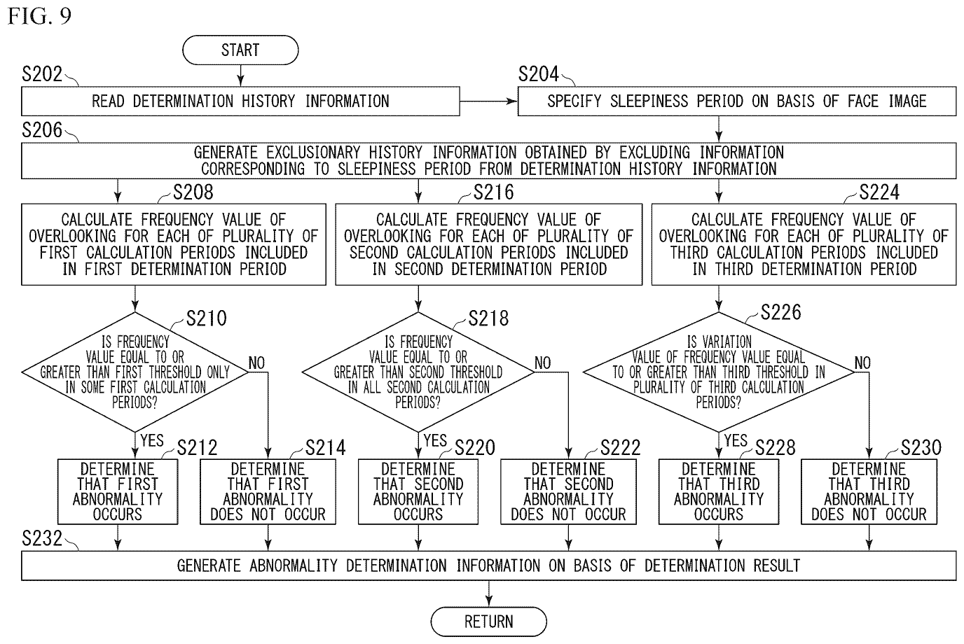

FIG. 9 is a flowchart illustrating an example of a flow of processing that is executed by the abnormality determination unit 46. The processing of the flowchart shown in FIG. 9 may be started, for example, repeatedly in a predetermined cycle, may be started each time the update of the determination history information 72 by the storage control unit 44 is performed, or may be started according to an instruction of the driver or the like.

First, the abnormality determination unit 46 reads the determination history information 72 from the storage unit 70 (Step S202). Next, the abnormality determination unit 46 specifies (estimates) a sleepiness period on the basis of the face image included in the read determination history information 72. The sleepiness period is a period during which the driver has sleepiness.

For example, the abnormality determination unit 46 may detect the number of times of opening/closing of an eyelid and/or an opening degree of the eyelid of the driver from the face image. Specifically, the abnormality determination unit 46 may detect the number of times of opening/closing of the eyelid and/or the opening degree of the eyelid by analyzing the face image using a predetermined image analysis method. Then, the abnormality determination unit 46 may specify the sleepiness period on the basis of the detected number of times of opening/closing of the eyelid and/or the opening degree of the eyelid. For example, the abnormality determination unit 46 may determine that the driver has sleepiness when the number of times of opening/closing of the eyelid is equal to or greater than a predetermined threshold or the opening degree of the eyelid is equal to or less than a predetermined threshold in a predetermined period. Then, a period during which the driver is determined to have sleepiness may be specified as a sleepiness period.

Next, the abnormality determination unit 46 generates exclusionary history information obtained by excluding information (determination information set J) corresponding to the specified sleepiness period from the determination history information 72 (Step S206). The exclusionary history information is information that is subject to abnormality determination described below, in the determination history information 72. That is, the abnormality determination unit 46 performs abnormality determination on the basis of the presence or absence of overlooking in a period other than the sleepiness period, instead of having all the determination history information 72 as information that is subject to abnormality determination. In this way, it is possible to increase the accuracy of the abnormality determination by the abnormality determination unit 46 by performing preprocessing of excluding information corresponding to the sleepiness period from the determination history information 72.

After the processing Step S206 is performed, the abnormality determination unit 46 executes processing (hereinafter, referred to as first processing) of Steps S208 to S214 processing (hereinafter, referred to as second processing) of Steps S216 to S222, and processing (hereinafter, referred to as third processing) of Steps S224 to S230 in parallel. The first processing is processing relating to the first abnormality. The second processing is processing relating to the second abnormality. The third processing is processing relating to the third abnormality. It should be noted that the abnormality determination unit 46 may sequentially perform two or third kinds of processing of the first processing, the second processing, and the third processing.

In processing of Step S208, the abnormality determination unit 46 calculates a frequency value of overlooking for each of a plurality of first calculation periods included in a first determination period on the basis of the exclusionary history information.

Here, the “first determination period” is a period that is used for the determination of the presence or absence of the first abnormality. The first determination period is set in advance, for example. The first determination period is, for example, one week (that is, seven days). It should be noted that the length of the first determination period can be suitably changed.

The “first calculation period” is a period that is used for the calculation of the frequency value in the determination of the presence or absence of the first abnormality. The first calculation period is shorter than the first determination period. The first calculation period is set in advance, for example. The plurality of first calculation periods may be periods obtained by dividing the first determination period into a predetermined number of periods. For example, when the first determination period is one week (seven days), the first determination period may include seven first calculation periods. In this case, each first calculation period is one day. It should be noted that the number of first calculation periods included in the first determination period and the length of each first calculation period can be suitably changed.

The “frequency value of overlooking” is a value indicating a frequency at which the driver has overlooked a risk object, and is a value that is greater as the frequency of overlooking is higher. The frequency value may be defined as, for example, the number of times the driver has overlooked a risk object. It should be noted that the definition of the frequency value is not limited thereto, and can be suitably changed. For example, the frequency value may be an overlooking rate. The overlooking rate is defined as, for example, a value obtained by dividing the number of times the driver has overlooked a risk object by the total number of risk objects that have occurred.

Next, the abnormality determination unit 46 determines whether the frequency value is equal to or greater than a first threshold only in some first calculation periods among the plurality of first calculation periods included in the first determination period (Step S210).

For example, when the first determination period is seven days, and each first calculation period is one day, the abnormality determination unit 46 determines that “the frequency value is equal to or greater than the first threshold only in some first calculation periods”, when the frequency value is equal to or greater than the first threshold only for one day or two days among the seven days. That is, the abnormality determination unit 46 determines that “the frequency value is equal to or greater than the first threshold only in some first calculation periods”, when a trend of transition of the frequency value (a trend of transition of the presence or absence of overlooking) in which the frequency value falls below the first threshold one day or several days after the frequency value is temporarily equal to or greater than the first threshold is recognized. The abnormality determination unit 46 determines that “the frequency value is equal to or greater than the first threshold only in some first calculation periods” when the frequency value is equal to or greater than the first threshold in the first calculation periods for a predetermined ratio or less among the plurality of first calculation periods included in the first determination period. On the contrary, when there is no day on which the frequency value is equal to or greater than the first threshold or when the frequency value is equal to or greater than the first threshold every day for the seven days, the abnormality determination unit 46 does not determine that “the frequency value is equal to or greater than the first threshold only in some first calculation periods”.

The first threshold is determined on the basis of a past frequency value of overlooking. For example, the first threshold may be determined on the basis of an average value of frequency values of overlooking by the driver of the vehicle M in a past predetermined period. For example, the first threshold is a value greater than the average value of the past frequency values. Specifically, the first threshold may be a value obtained by adding or multiplying a predetermined value to the average value of the past frequency values. For example, in Step S208, each time the frequency value is calculated, the calculated frequency value may be stored (accumulated) in the storage unit 70. Then, the abnormality determination unit 46 may calculate the first threshold on the basis of the past frequency values stored in the storage unit 70.

When determination is made that “the frequency value is equal to or greater than the first threshold only in some first calculation periods” (Step S210; YES), the abnormality determination unit 46 determines that the first abnormality occurs in the driver (Step S212). When determination is not made that “the frequency value is equal to or greater than the first threshold only in some first calculation periods” (Step S210; NO), the abnormality determination unit 46 determines that the first abnormality does not occur in the driver (Step S214).

When the driver has the first abnormality (has or is likely to have accumulated fatigue), the frequency of the overlooking by the driver increases, compared to when the driver does not have the first abnormality. However, fatigue is improved by sleep or the like. For this reason, the increase of the frequency of the overlooking is merely temporary, and it is expected that the frequency value returns to a normal value (that is, a value equivalent to the frequency value in the past) again after one day or several days. The first processing described above can detect the first abnormality by detecting the temporary increase of the frequency of the overlooking.

In processing of Step S216, the abnormality determination unit 46 calculates a frequency value of overlooking for each of a plurality of second calculation periods included in a second determination period on the basis of the exclusionary history information.

Here, the “second determination period” is a period that is used for the determination of the presence or absence of the second abnormality. The second determination period is set in advance, for example. The second determination period may be longer than the first determination period. The second determination period is, for example, about one month to several years. It should be noted that the length of the second determination period can be suitably changed.

The “second calculation period” is a period that is used for the calculation of the frequency value of the overlooking in the determination of the presence or absence of the second abnormality. The second calculation period is shorter than the second determination period. The second calculation period is set in advance, for example. A plurality of second calculation periods may be periods obtained by dividing the second determination period into a predetermined number of periods. For example, when the second determination period is one month (31 days), the second determination period may include 31 second calculation periods. In this case, each second calculation period is one day. It should be noted that the number of second calculation periods included in the second determination period and the length of each second calculation period can be suitably changed.

Next, the abnormality determination unit 46 determines that the frequency value is equal to or greater than a second threshold in all second calculation periods included in the second determination period (Step S218).

For example, when the second determination period is 31 days, and each second calculation period is one day, the abnormality determination unit 46 determines that “the frequency value is equal to or greater than the second threshold in all second calculation periods”, when the frequency value is equal to or greater than the second threshold every data for 31 days”. That is, the abnormality determination unit 46 determines that “the frequency value is equal to or greater than the second threshold in all second calculation periods”, when a state in which the frequency value is equal to or greater than the second threshold is continued between the second calculation periods. On the contrary, when there is a day on which the frequency value is less than the second threshold, the abnormality determination unit 46 does not determine that “the frequency value is equal to or greater than the second threshold in all second calculation periods”.

The second threshold is determined on the basis of a past frequency value of overlooking. For example, the second threshold may be determined on the basis of an average value of frequency values of overlooking by the driver of the vehicle M in a past determined period. For example, the second threshold is a value greater than the average value of the past frequency values. Specifically, the second threshold may be a value obtained by adding or multiplying a predetermined value to the average value of the past frequency values. For example, in Step S216, each time the frequency value is calculated, the calculated frequency value may be stored (accumulated) in the storage unit 70. Then, the abnormality determination unit 46 may calculate the second threshold on the basis of the past frequency values stored in the storage unit 70. The second threshold may be the same value as or a value different from the first threshold.

When determination is made that “the frequency value is equal to or greater than the second threshold in all second calculation periods” (Step S218; YES), the abnormality determination unit 46 determines that the second abnormality occurs in the driver (Step S220). When determination is not made that “the frequency value is equal to or greater than the second threshold in all second calculation periods” (Step S218; NO), the abnormality determination unit 46 determines that the second abnormality does not occur in the driver (Step S222).

When the driver has the second abnormality (has or is likely to have visual field loss such as visual field narrowing), the frequency of the overlooking by the driver increases, compared to when the driver does not have the second abnormality. Because visual field loss is not recovered unlike fatigue, it is expected that the increase of the overlooking frequency is continued. The second processing described above can detect the second abnormality by detecting the continuation of the increase of the overlooking frequency.

In processing of Step S224, the abnormality determination unit 46 calculates a frequency value of overlooking for each of a plurality of third calculation periods included in a third determination period on the basis of the exclusionary history information.

Here, the “third determination period” is a period that is used for the determination of the presence or absence of the third abnormality. The third determination period is set in advance, for example. The third determination period is longer than the first determination period. The third determination period is, for example, about one month to several years. It should be noted that the length of the third determination period can be suitably changed. The third determination period may be the same as or different from the second determination period.

The “third calculation period” is a period that is used for the calculation of the frequency value of the overlooking in the determination of the presence or absence of the third abnormality. The third calculation period is shorter than the third determination period. The third calculation period is set in advance, for example. The plurality of third calculation periods may be periods obtained by dividing the third determination period into a predetermined number of periods. For example, when the third determination period is one month (31 days), the third determination period may include 31 third calculation periods. In this case, each third calculation period is one day. It should be noted that the number of third calculation periods included in the third determination period and the length of each third calculation period can be suitably changed. The third calculation period may be the same as or different from the second calculation period.

Next, the abnormality determination unit 46 determines whether a variation value of a frequency value is equal to or greater than a third threshold in a plurality of third calculation periods included in a third determination period (Step S226).

Here, the “variation value of a frequency value” is a value indicating the magnitude of variation of the frequency value in the plurality of third calculation periods, and is a value that is greater as the variation of the frequency value is greater. The variation value may be defined as, for example, a difference between a maximum value and a minimum value of the frequency value in the plurality of third calculation periods. It should be noted that the definition of the variation value is not limited thereto, and can be suitably changed. For example, the variation value may be, for example, a variance or a standard deviation of the frequency value in the plurality of third calculation periods.

The third threshold may be determined in advance, for example. Alternatively, the third threshold may be determined on the basis of a variation value of a past frequency value. In this case, the third threshold may be a value greater than the variation value of the past frequency value. Specifically, the third threshold may be a value obtained by adding or multiplying a predetermined value to the variation value of the past frequency value. For example, in Step S224, each time the frequency value is calculated, the calculated frequency value may be stored (accumulated) in the storage unit 70. Then, the abnormality determination unit 46 may calculate the variation value of the past frequency value on the basis of the past frequency values stored in the storage unit 70, and the third threshold based on the variation value of the past frequency value. Alternatively, each time the abnormality determination unit 46 calculates the variation value, the calculated variation value may be stored (accumulated) in the storage unit 70. Then, the abnormality determination unit 46 may calculate the third threshold on the basis of the past variation values stored in the storage unit 70. The third threshold may be the same value as or a value different from the first threshold or the second threshold.

When determination is made that “the variation value of the frequency value is equal to or greater than the third threshold in the plurality of third calculation periods” (Step S226; YES), the abnormality determination unit 46 determines that the third abnormality occurs in the driver (Step S228). When determination is not made that “the variation value of the frequency value is equal to or greater than the third threshold in the plurality of third calculation periods” (Step S226; NO), the abnormality determination unit 46 determines that the third abnormality does not occur in the driver (Step S230).

The present inventors have conducted intense studies and have found that, when the driver has the third abnormality (has or is likely to have dementia), a difference of the frequency of the overlooking between a day on which the frequency of the overlooking is high and a day on which the frequency of the overlooking is low tends to increase, compared to when the driver does not have the third abnormality. The third processing described above can detect the third abnormality by detecting the increase in level difference of the frequency of the overlooking.

After the first processing, the second processing, and the third processing end, the abnormality determination unit 46 generates the abnormality determination information on the basis of the above-described determination result (Step S232). That is, the abnormality determination unit 46 generates the abnormality determination information on the basis of the determination result relating to the presence or absence of the first abnormality, the determination result relating to the presence or absence of the second abnormality, and the determination result relating to the presence or absence of the third abnormality.

Returning to FIG. 7, the notification control unit 54 causes the first terminal device T1 (notification unit 84) to output a notification on the basis of the abnormality determination information. For example, the notification control unit 54 transmits notification information to the first terminal device T1 (notification unit 84) via the communication unit 60. For example, in the abnormality determination information, at least one of information indicating that there is the first abnormality in the driver, information indicating that there is the second abnormality in the driver, and information indicating that there is the third abnormality in the driver is included (that is, when the abnormality determination unit 46 determines that at least one of the first abnormality to the third abnormality occurs in the driver), the notification control unit 54 may transmit the notification information to the first terminal device T1. In the notification information, for example, information indicating the content (the first abnormality, the second abnormality, the third abnormality) of the abnormality of the driver is included. When all of information indicating there is no first abnormality in the driver, information indicating that there is no second abnormality in the driver, and information indicating that there is no third abnormality in the driver are included in the abnormality determination information (that is, when the abnormality determination unit 46 determines that none of the first abnormality, the second abnormality, or the third abnormality occurs in the driver), the notification control unit 54 may not transmit the notification information to the first terminal device T1.

The first terminal device T1 (notification unit 84) outputs a notification on the basis of the notification information. The notification may be performed, for example, by displaying a character string, an image, or the like based on the notification information on the display device of the first terminal device T1 (notification unit 84). The first terminal device T1 (notification unit 84) may perform a notification according to the content (the first abnormality, the second abnormality, the third abnormality) of the abnormality of the driver. For example, when information indicating the first abnormality is included in the notification information, the first terminal device T1 (notification unit 84) may perform a notification indicating that the driver has or is likely to have accumulated fatigue. This notification is an example of a “first notification”. When information indicating the second abnormality is included in the notification information, the first terminal device T1 (notification unit 84) may perform a notification indicating that the driver is suffering from or is likely to be suffering from visual field loss. This notification is an example of a “second notification”. When information indicating the third abnormality is included in the notification information, the first terminal device T1 (notification unit 84) may perform a notification indicating that the driver is suffering from or is likely to be suffering from dementia. This notification is an example of a “third notification”.

In the first notification, the content for prompting to improve lifestyle habits such that fatigue is not accumulated may be included. In the notification (for example, the second notification and the third notification) by the first terminal device T1 (notification unit 84), the content regarding a recommendation to receive a medical examination of a medical institution (for example, a family doctor of the driver) may be included. In this case, the first terminal device T1 (notification unit 84) may cause the driver to input information indicating whether the driver accepts to receive the medical examination of the medical institution. Specifically, a virtual button or the like indicating that the driver accepts to receive the medical examination may be displayed on the display device of the first terminal device T1 (notification unit 84). Such a button or the like functions as an acceptance information acquisition unit that acquires information (hereinafter, referred to as acceptance information) indicating the intention of the driver to accept to receive the medical examination of the medical institution. Then, when the driver operates the first terminal device T1 (notification unit 84), and the acceptance information acquisition unit acquires the acceptance information, the first terminal device T1 (notification unit 84) may cause a predetermined information processing terminal to perform a notification indicating that the driver accepts to receive the medical examination. The predetermined information processing terminal may be, for example, a terminal (for example, second terminal device T2 described below) that is used in the medical institution. Specifically, the predetermined information processing terminal may be, for example, a terminal that is used by personnel (for example, a physician or a nurse) belonging to the medical institution.

It should be noted that an aspect of notification by the first terminal device T1 (notification unit 84) is not particularly limited as long as the driver can recognize the aspect, and can be suitably changed.

The notification by the first terminal device T1 (notification unit 84) may be performed, for example, at a timing other than the timing at which the driver is driving the vehicle M. Examples of “the timing other than the timing at which the driver is driving the vehicle M” include a timing at which the vehicle M is stopped, a timing after the drivers ends the driving of the vehicle M, and a timing at which the driver is separated from the vehicle M and stays at home. For example, the transmission of the notification information by the notification control unit 54 may be performed at the above-described timing. Alternatively, the transmission of the notification information by the notification control unit 54 may be performed at any timing, and the first terminal device T1 (notification unit 84) may control a timing of notification such that the notification is performed at the above-described timing.

According to the first embodiment described above, the information processing device 2 includes the risk detection unit 32 that detects the risk object positioned surrounding the vehicle M, the acquisition unit 20 that acquires the face image of the driver of the vehicle M, the overlooking determination unit 42 that determines the presence or absence of overlooking of the risk object by the driver on the basis of information relating to the position of the risk object and information relating to the face image, the abnormality determination unit 46 that determines whether an abnormality occurs in the driver on the basis of the trend of transition of the presence or absence of the overlooking, and the notification control unit 54 that causes the notification unit 84 to perform a notification when the abnormality occurs in the driver. With this, it is possible to detect an abnormality of the driver.

### Second Embodiment

Next, while a second embodiment will be described, a basic configuration is similar to the first embodiment. For this reason, similar configurations are represented by the same reference numbers, and description thereof will not be repeated. Only differences will be described.

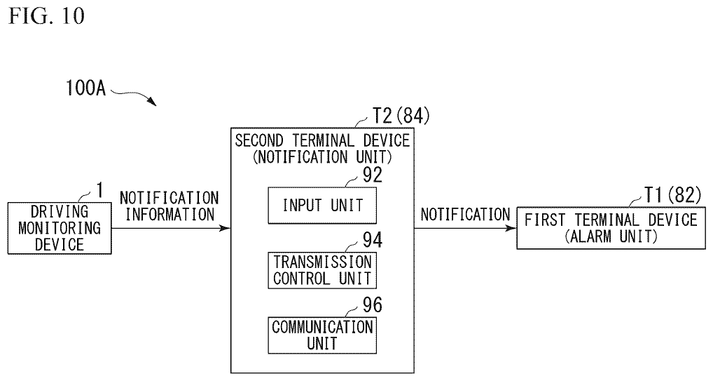

FIG. 10 is a diagram illustrating abnormality notification processing in an information processing system 100A according to the second embodiment. As shown in FIG. 10, the information processing system 100A according to the second embodiment includes a second terminal device T2 in addition to the driving monitoring device 1 and the first terminal device T1.

The second terminal device T2 is an information processing device that is used by a user (for example, a staff member of a hospital or an insurance company) different from the driver who uses the first terminal device T1. The second terminal device T2 may be, for example, a smartphone, a tablet terminal, or a personal computer.

In the second embodiment, the driving monitoring device 1 (notification control unit 54) transmits the notification information to the second terminal device T2, not to the first terminal device T1. That is, in the second embodiment, the notification unit 84 in which the notification is controlled by the notification control unit 54 is the second terminal device T2, not the first terminal device T1. In the second terminal device T2, for example, an application for receiving the notification by the information processing device 2 is executed. The application displays an image, a character string, or the like based on information (notification information or the like) transmitted from the information processing device 2 on the display device or causes a speaker to emit sound.

The second terminal device T2 causes the first terminal device T1 to perform a notification on the basis of information input by an operation of the user. The second terminal device T2 includes, for example, an input unit 92, a transmission control unit 94, and a communication unit 96.

For the input unit 92 and the transmission control unit 94, the function of each component is implemented, for example, by providing a hardware processor such as a CPU and a storage device (a storage device including a non-transitory storage medium) storing a program (software) and causing the processor to execute the program. Some or all of these components may be implemented by hardware (including a circuit unit) such as an LSI, an ASIC, an FPGA, or a GPU or the function of each component may be implemented by cooperation of software and hardware. For some or all of these components, the function of each component may be implemented by a dedicated LSI. The communication unit 96 is an interface for performing wireless communication or wired communication with an information processing device such as the first terminal device T1.

The input unit 92 receives an operation of the user and inputs the operation to the second terminal device T2. The input unit 92 is configured using existing input devices such as a keyboard, a pointing device (a mouse, a tablet, or the like), a button, and a touch panel. The input unit 92 may be an interface for connecting an input device to the second terminal device T2. In this case, the input unit 92 inputs an input signal generated according to an operation of the user on the input device to the second terminal device T2. The input unit 92 may have any configuration as long as a configuration is made in which an instruction based on an operation of the user can be input to the second terminal device T2.

For example, the user confirms the content of the notification from the second terminal device T2 caused by the driving monitoring device 1 (notification control unit 54), and examines the content that should be notified to the driver. The content to be notified to the driver is, for example, a recommendation of a medical examination of a medical institution for finding out the possibility of a disease (abnormality) such as dementia visual field loss or the disease. The user inputs information including the examined notification content to the second terminal device T2 by operating the input unit 92. The transmission control unit 94 transmits information input by the operation of the user to the first terminal device T1 via the communication unit 96. The first terminal device T1 performs a notification to the driver on the basis of the transmitted information.

The information processing system 100A may be configured to regulate the transmission of the notification information to the second terminal device T2 by the driving monitoring device 1 (notification control unit 54) according to an operation of the driver on the first terminal device T1 or the driving monitoring device 1. For example, regulation information indicating the presence or absence of regulation of the transmission of the notification information may be generated according to an operation of the driver on the first terminal device T1 or the driving monitoring device 1, and the generated regulation information may be stored in the storage unit 70. Then, the alarm control unit 52 may determine whether to transmit the notification information to the second terminal device T2, on the basis of the regulation information stored in the storage unit 70. According to such a configuration, determination regarding whether to inform the user who uses the second terminal device T2 of information relating to an abnormality of the driver is performed according to the intention of the driver. Accordingly, the privacy of the driver is easily protected.

According to the second embodiment described above, the information processing system 100A includes the information processing device 2, the first terminal device T1 that is used by the driver and is not the notification unit 84 in which the notification is controlled by the notification control unit 54, and the second terminal device T2 that is used by the user different from the driver and is the notification unit 84 in which the notification is controlled by the notification control unit 54, and the second terminal device T2 causes the first terminal device T1 to perform a notification on the basis of information input by the operation of the user. With this, the notification content examined by the user who uses the second terminal device T2 can be provided to the driver who uses the first terminal device T1.

### MODIFICATION EXAMPLES

The technical scope of the present invention is not limited to the above-described embodiments, and various changes may be made without departing from the spirit of the present invention.

For example, in the above-described embodiments, while the risk detection unit 32 detects the risk object by image analysis on the surrounding image, the configuration of the risk detection unit 32 is not limited thereto. For example, various sensors provided in the vehicle M or the like or and ECU of the vehicle M that manages these sensors may be connected to a network NW, and the risk detection unit 32 may detect a risk object on the basis of signals output from these sensors. Examples of the sensors include a radar device and a light detection and ranging (LIDAR). A detection method of the risk object in the risk detection unit 32 is not limited to these examples, and can be suitably changed.

The driving monitoring device 1 (information processing device 2) may perform another alarm processing (hereinafter, referred to as auxiliary alarm processing) in addition (or instead of) the above-described overlooking alarm processing. The auxiliary alarm processing may be, for example, collision alarm processing of detecting a possibility of collision of a risk object against the vehicle M on the basis of the position or relative speed of the risk object with respect to the vehicle M and causing the alarm unit 82 to give an alarm. In the collision alarm processing, the relative speed of the risk object with respect to the vehicle M may be calculated, for example, by analyzing a temporal change of the risk position detected by the risk detection unit 32 with the processing unit 40. When the possibility of collision of the risk object against the vehicle M is detected by the processing unit 40, the alarm control unit 52 may cause the alarm unit 82 to perform an alarm. Similarly to the overlooking alarm processing, the auxiliary alarm processing may be performed at the timing (that is, in real time) at which the driver is driving the vehicle M. In the configuration in which the driving monitoring device 1 (information processing device 2) performs the auxiliary alarm processing, the alarm by the alarm unit 82 based on the result of determination of overlooking by the overlooking determination unit 42 may not be performed. Also in this case, the determination of overlooking by the overlooking determination unit 42 is executed for the above-described abnormality notification processing.

Information relating to the result of the determination of overlooking by the overlooking determination unit 42, and the like are integrated in the storage unit 70 (for example, the determination history information 72), and contents (hereinafter, referred to as “review contents”) that are generated on the basis of the integrated information and allows the driver to review his/her driving in the past may be provided to the driver by the first terminal device T1 (alarm unit 82). The review contents may include, for example, information (character string, image, or the like) that allows the driver to confirm a risk object overlooked by the driver. The review contents may be generated by the driving monitoring device 1 (information processing device 2) or may be generated by the first terminal device T1 (alarm unit 82).

In the information processing system 100A according to the second embodiment, the driving monitoring device 1 (notification control unit 54) may transmit the notification information to both the first terminal device T1 and the second terminal device T2. In other words, both the first terminal device T1 and the second terminal device T2 may be the notification unit 84 in which a notification is controlled by the notification control unit 54.

In the first embodiment, the driving monitoring device 1 (information processing device 2) and the first terminal device T1 are configured as different devices, but may be configured as an integrated device. For example, all the functions of the imaging unit 10, the acquisition unit 20, the detection unit 30, the processing unit 40, the control unit 50, the storage unit 70, the alarm unit 82, and the notification unit 84 may be mounted in the driving monitoring device 1. Alternatively, all these functions may be mounted in the first terminal device T1 or the vehicle M. Also in the second embodiment, similarly, all the functions of the imaging unit 10, the acquisition unit 20, the detection unit 30, the processing unit 40, the control unit 50, the storage unit 70, and the alarm unit 82 may be mounted in the driving monitoring device 1 or all these functions may be mounted in the first terminal device T1. A camera other than the camera in the driving monitoring device 1 may be allowed to have a part or all of the functions of the imaging unit 10. For example, a driver monitor camera that images the driver may capture the face image.

The driving monitoring device 1 may be mounted using a plurality of information processing devices. For example, the functions of the information processing device 2 may be mounted in the first terminal device T1 or the vehicle M (for example, the ECU). Alternatively, the driving monitoring device 1 may be mounted using a device such as a cloud. For example, in the driving monitoring device 1, the detection unit 30, the processing unit 40, the control unit 50, and the storage unit 70 may be mounted in different information processing devices. For example, the storage unit 70 may be distributed and mounted in a plurality of information processing devices.

The embodiments and the modification examples described above can be expressed as follows.

An information processing device including
a storage medium that stores computer-readable instructions, and
a processor connected to the storage medium,

in which the processor executes the computer-readable instructions to detect a risk object positioned surrounding a vehicle,
acquire a face image of a driver of the vehicle,
determine presence or absence of overlooking of the risk object by the driver on the basis of information relating to a position of the risk object and information relating to the face image,
determine whether an abnormality occurs in the driver on the basis of a trend of transition of the presence or absence of the overlooking,
cause a notification unit to perform a notification when determination is made that the abnormality occurs in the driver.

The components in the embodiments described above can be appropriately replaced with well-known components without departing from the spirit of the present invention, and the embodiments and the modification examples described above may be appropriately combined.

What is claimed is:

1. An information processing device comprising:
a risk detection unit configured to detect a risk object positioned surrounding a vehicle;
an acquisition unit configured to acquire a face image of a driver of the vehicle;
an overlooking determination unit configured to determine presence or absence of overlooking of the risk object by the driver on the basis of information relating to a position of the risk object and information relating to the face image;
an abnormality determination unit configured to determine whether an abnormality occurs in the driver on the basis of a trend of transition of the presence or absence of the overlooking; and
a notification control unit configured to cause a notification unit to perform a notification when determination is made that the abnormality occurs in the driver.

2. The information processing device according to claim 1,
wherein the abnormality determination unit is configured to calculate a frequency value of the overlooking for each of a plurality of first calculation periods included in a first determination period, and determine that a first abnormality occurs in the driver when the frequency value is equal to or greater than a first threshold determined on the basis of a past frequency value of overlooking only in some first calculation periods among the plurality of first calculation periods, and
the notification control unit is configured to cause the notification unit to perform a first notification when determination is made that the first abnormality occurs in the driver.

3. The information processing device according to claim 1,
wherein the abnormality determination unit is configured to calculate a frequency value of the overlooking for each of a plurality of second calculation periods included in a second determination period, and determines that a second abnormality occurs in the driver when the frequency value is equal to or greater than a second threshold determined on the basis of a past frequency value of overlooking in all second calculation periods among the plurality of second calculation periods, and
the notification control unit is configured to cause the notification unit to perform a second notification when the second abnormality occurs in the driver.

4. The information processing device according to claim 1,
wherein the abnormality determination unit is configured to calculate a frequency value of the overlooking for each of a plurality of third calculation periods included in a third determination period, and determine that a third abnormality occurs in the driver when a variation value of the frequency value in the plurality of third calculation periods is equal to or greater than a third threshold, and
the notification control unit is configured to cause the notification unit to perform a third notification when determination is made that the third abnormality occurs in the driver.

5. The information processing device according to claim 1,
wherein the abnormality determination unit is configured to specify a sleepiness period during which the driver has sleepiness, on the basis of the face image, and determine whether the abnormality occurs in the driver on the basis of the presence or absence of the overlooking in a period other than the specified sleepiness period.

6. The information processing device according to claim 5,
wherein the abnormality determination unit is configured to specify the sleepiness period on the basis of the number of times of opening/closing an eyelid of the driver and/or an opening degree of the eyelid detected from the face image.

7. An information processing system comprising:
the information processing device according to claim 1;
a first terminal device that is used by the driver and is not the notification unit in which the notification is controlled by the notification control unit; and
a second terminal device that is used by a user different from the driver and is the notification unit in which the notification is controlled by the notification control unit,
wherein the second terminal device causes the first terminal device to perform a notification on the basis of information input by an operation of the user.

8. An information processing method causing a computer to execute:
processing of detecting a risk object positioned surrounding a vehicle;
processing of acquiring a face image of a driver of the vehicle;
processing of determining presence or absence of overlooking of the risk object by the driver on the basis of information relating to a position of the risk object and information relating to the face image;
processing of determining whether an abnormality occurs in the driver on the basis of a trend of transition of the presence or absence of the overlooking; and
processing of causing a notification unit to perform a notification when determination is made that the abnormality occurs in the driver.

9. A non-transitory computer-readable storage medium storing a program causing a computer to execute:
processing of detecting a risk object positioned surrounding a vehicle;
processing of acquiring a face image of a driver of the vehicle;
processing of determining presence or absence of overlooking of the risk object by the driver on the basis of information relating to a position of the risk object and information relating to the face image;
processing of determining whether an abnormality occurs in the driver on the basis of a trend of transition of the presence or absence of the overlooking; and
processing of causing a notification unit to perform a notification when determination is made that the abnormality occurs in the driver.
